(19) United States
(12) Patent Application Publication
(10) Pub. No.: US 2025/0200652 A1
(43) Pub. Date: Jun. 19, 2025

(54) SYSTEMS AND METHODS FOR USING MACHINE LEARNING TO ADJUST CREDIT LIMITS PROVIDED TO RETAILERS UTILIZING A BUSINESS-TO-BUSINESS MARKETPLACE PLATFORM

(71) Applicant: Faire Wholesale, Inc., San Francisco, CA (US)

(72) Inventor: Dongpeng Liu, Oakton, VA (US)

(73) Assignee: Faire Wholesale, Inc., San Francisco, CA (US)

(21) Appl. No.: 18/389,611

(22) Filed: Dec. 19, 2023

(51) Int. Cl. G06Q 40/03

(52) U.S. Cl. CPC G06Q 40/03

(57) ABSTRACT

Computer implemented method and systems for using machine learning to adjust a respective credit limit of one or more retailers that utilize a B2B marketplace platform to make product orders, are disclosed herein. Such a method includes collecting retailer data for retailers that utilized the B2B marketplace platform, and identifying cohorts based on the retailer data. The method also includes producing, based on the cohorts, a plurality of sets of ML models that include a set of risk ML models, a set of non-defaulter value ML models, and a set of defaulter value ML models, each of which sets include respective cohort-based ML scoring models and a cohort-based ML aggregation model. The method also includes using scores produces by the sets of ML models to determine whether, and to what extent, to adjust the credit limit of a retailer.

### FIELD

Embodiments of the present technology generally relate to a business-to-business (B2B) marketplace platform, and more specifically, to using machine learning to identify which users of the B2B marketplace platform should have their credit limits adjusted, and using machine learning to determine an extent of the adjustments to the credit limit of the identified users.

### BACKGROUND

A B2B marketplace platform may enable retailers to utilize credit to purchase products from brands (aka wholesalers), so that the retailers can sell the products to customers, and use the profits from the sales of the products to pay for the purchased products. In order for such a B2B marketplace to operate effectively, credit limits provided to individual retailers should be appropriately adjusted (increased or decreased) when appropriate in a manner that both mitigates risks to the parties involved while also attempting to maximize the benefits to the parties involved. In the past, credit limits have been adjusted using human reviewers of the retailers' purchases, payments, and the like. However, such prior techniques for adjusting credit limits are typically reactionary and do not take into account information that could be gleaned from retailer data if the retailer data were appropriately analyzed in a manner that would not be possible by solely relying on human review.

### SUMMARY

Certain embodiments of the present technology are directed to computer implemented methods for using machine learning to adjust a respective credit limit of one or more retailers that utilize a business-to-business (B2B) marketplace platform to make product orders. In accordance with certain embodiments, such a method includes collecting retailer data for retailers that have utilized the B2B marketplace platform to make product orders during a specified period of time, and identifying a plurality cohorts based on the retailer data. Each cohort, of the plurality of cohorts, has a different respective cohort snapshot date within the specified period of time. Further, each cohort, of the plurality of cohorts, includes a group of the retailers that made at least one of the product orders within a specified window of time following the cohort snapshot date. The method also includes producing, based on the retailer data, a plurality of sets of machine learning (ML) models that include a set of risk ML models, a set of non-defaulter value ML models, and a set of defaulter value ML models. Each of the sets of the ML models includes a plurality of cohort-based ML models. Each of the plurality of cohort-based ML models, of each of the sets of the ML models, includes at least two cohort-based ML scoring models, and a cohort-based ML aggregation model. Each of the plurality of cohort-based ML models, of each of the sets of the ML models, corresponds to a different cohort of the plurality of cohorts. In accordance with certain embodiments, the set of risk ML models comprise classification models, and the set of non-defaulter value ML models and the set of defaulter value ML models comprise regression models.

The method also includes for each retailer, of at least some of the retailers that have utilized the B2B marketplace platform to make product orders during the specified period of time, using the at least two cohort-based ML scoring models of the set of risk ML models to produce at least two risk scores, and using the cohort-based ML aggregation model of the set of risk ML models to aggregate the at least two risk scores into an aggregated risk score indicative of a predictive risk that the retailer will default on at least one product order (aka brand order) made within a further specified window of time. The method also includes for each retailer, of at least some of the retailers that have utilized the B2B marketplace platform to make product orders (aka brand orders) during the specified period of time, using the at least two cohort-based ML scoring models of the set of non-defaulter value ML models to produce at least two non-defaulter value scores, and using the cohort-based ML aggregation model of the set of non-defaulter value ML models to aggregate the at least two non-defaulter value scores into an aggregated non-defaulter value score indicative of a predicted value of one or more orders the retailer will make if the retailer does not default on any product orders within the further specified window of time. The method also includes for each retailer, of at least some of the retailers that have utilized the B2B marketplace platform to make product orders during the specified period of time, using the at least two cohort-based ML scoring models of the set of defaulter value ML models to produce at least two defaulter value scores, and using the cohort-based ML aggregation model of the set of defaulter value ML models to aggregate the at least two defaulter value scores into an aggregated defaulter value score indicative of a predicted value of one or more orders the retailer will make if the retailer does default on at least one product order made within the further specified window of time.

The method also includes for each retailer, of at least some of the retailers that have utilized the B2B marketplace platform to make product orders during the specified period of time, determining whether to adjust the credit limit of the retailer based on the aggregated risk score, the aggregated non-defaulter value score, and the aggregated defaulter value score for the retailer, that were produced using the plurality of sets of ML models. In accordance with certain embodiments, determining whether to adjust the credit limit of the retailer additionally, or alternatively, includes determining whether the retailer is in need of an increased credit limit, and determining that the credit limit of the retailer should be increased is also responsive determining that the retailer is in need of the increased credit limit. In accordance with certain embodiments, the aggregated risk score, the aggregated non-defaulter value score, and the aggregated defaulter value score are updated periodically (e.g., daily) for each retailer of at least some of the retailers, thereby enabling a determination of whether to adjust the credit limit of at least some of the retailers to be repeated periodically (e.g., daily).

In accordance with certain embodiments, determining whether to adjust the credit limit of the retailer includes: determining an expected reward for the retailer based on the aggregated risk score, the aggregated non-defaulter value score, and the aggregated defaulter value score produced using the plurality of sets of ML models for the retailer; and determining that the credit limit of the retailer should be increased responsive to the expected reward for the retailer exceeding a corresponding reward threshold and the aggregated risk score for the retailer being below a corresponding acceptable risk threshold. Additionally, one or more guardrail type heuristics may be used when determining whether to adjust the credit limit of the retailer.

In accordance with certain embodiments, the method further comprises, responsive to determining that the credit limit of the retailer should be increased, determining an increased credit limit of the retailer or an amount by which to increase the credit limit of the retailer. In accordance with certain such embodiments, determining the increased credit limit of the retailer or the amount by which to increase the credit limit of the retailer is performed based on the aggregated non-defaulter value score and a current credit limit utilization of the retailer.

In accordance with certain embodiments, determining whether to adjust the credit limit of the retailer includes: determining an expected reward for the retailer based on the aggregated risk score, the aggregated non-defaulter value score, and the aggregated defaulter value score produced using the plurality of sets of ML models for the retailer; and determining that the credit limit of the retailer should be decreased responsive to the expected reward for the retailer falling below a corresponding reward threshold and the aggregated risk score for the retailer being indicative of the retailer having an unacceptable risk of defaulting. In accordance with certain embodiments, the method further comprises, responsive to determining that the credit limit of the retailer should be decreased, determining a decreased credit limit of the retailer or an amount by which to decrease the credit limit of the retailer.

In accordance with certain embodiments, producing, based on the retailer data, the plurality of sets of ML models that include the set of risk ML models, the set of non-defaulter value ML models, and the set of defaulter value ML models, includes for each cohort-based ML model included in the plurality of sets of ML models: splitting the retailer data for one of the cohorts into retailer training data and retailer testing data; training and tuning the ML cohort-based model using the retailer training data and the retailer testing data; performing feature pruning on the ML model; and finalizing the ML model after performing the feature pruning.

In accordance with certain embodiments, the method further comprises for each set of ML models, of the plurality of sets of the ML models that include the set of risk ML models, the set of non-defaulter value ML models, and the set of defaulter value ML models: periodically (e.g., monthly, or every two months) retiring an oldest one of the at least two cohort-based ML scoring models and the cohort-based ML aggregation model produced for the set, and producing a new cohort-based ML scoring model and a new cohort-based ML aggregation model to be included in the plurality of cohort-based ML models.

Certain embodiments of the present technology are directed to systems for using machine learning to adjust a respective credit limit of one or more retailers that utilize a B2B marketplace platform to make product orders. In accordance with certain embodiments, such a system comprises a data store that stores retailer data for retailers that have utilized the B2B marketplace platform to make product orders during a specified period of time. The system also comprises one or more processors interfaced with the data store and configured to: identify a plurality of cohorts based on the retailer data, and produce, based on the retailer data, a plurality of sets of ML models that include a set of risk ML models, a set of non-defaulter value ML models, and a set of defaulter value ML models. Each cohort, of the plurality of cohorts, has a different respective cohort snapshot date within the specified period of time. Each cohort, of the plurality of cohorts, includes a group of the retailers that made at least one of the product orders within a specified window of time following the cohort snapshot date. Each of the sets of the ML models includes plurality of cohort-based ML models. Each of the plurality of cohort-based ML models, of each of the sets of the ML models, includes at least two cohort-based ML scoring models, and a cohort-based ML aggregation model. Each of the plurality of cohort-based ML models, of each of the sets of the ML models, corresponds to a different cohort of the plurality of cohorts.

Additionally, the one or more processors of the system are configured to for each retailer, of at least some of the retailers that have utilized the B2B marketplace platform to make product orders during the specified period of time, use the at least two cohort-based ML scoring models of the set of risk ML models to produce at least two risk scores, and use the cohort-based ML aggregation model of the set of risk ML models to aggregate the at least two risk scores into an aggregated risk score indicative of a predictive risk that the retailer will default on at least one product order made within a further specified window of time. Additionally, the one or more processors of the system are configured to for each retailer, of at least some of the retailers that have utilized the B2B marketplace platform to make product orders during the specified period of time, are configured to use the at least two cohort-based ML scoring models of the set of non-defaulter value ML models to produce at least two non-defaulter value scores, and use the cohort-based ML aggregation model of the set of non-defaulter value ML models to aggregate the at least two non-defaulter value scores into an aggregated non-defaulter value score indicative of a predicted value of one or more orders the retailer will make if the retailer does not default on any product orders within the further specified window of time. Additionally, the one or more processors of the system are configured to for each retailer, of at least some of the retailers that have utilized the B2B marketplace platform to make product orders during the specified period of time, use the at least two cohort-based ML scoring models of the set of defaulter value ML models to produce at least two defaulter value scores, and using the cohort-based ML aggregation model of the set of defaulter value ML models to aggregate the at least two defaulter value scores into an aggregated defaulter value score indicative of a predicted value of one or more orders the retailer will make if the retailer does default on at least one product order made within the further specified window of time.

Additionally, the one or more processors of the system are configured to for each retailer, of at least some of the retailers that have utilized the B2B marketplace platform to make product orders during the specified period of time, determine whether to adjust the credit limit of the retailer based on the aggregated risk score, the aggregated non-defaulter value score, and the aggregated defaulter value score for the retailer, that were produced using the plurality of sets of ML models.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high level block diagram that is used to describe an example computer implemented environment in which certain embodiments of the present technology may be utilized.

FIG. 2 is a high level block diagram showing example details of a B2B marketplace platform introduced in FIG. 1.

FIG. 3 is a high level block diagram high level flow diagram used to summarize methods according to certain embodiments of the present technology that use machine learning to adjust a respective credit limit of one or more retailers that use a B2B marketplace platform to make product orders.

FIG. 4 is a high level block diagram illustrating an example of cohorts identified at one of the steps in FIG. 3.

FIG. 5 is a high level block diagram illustrating different types of sets of ML models generated and used in certain embodiments of the present technology.

FIG. 6 illustrates an example set of risk models produced at one of the steps in FIG. 3.

FIG. 7 illustrates an example set of non-defaulter value models produced at one of the steps in FIG. 3.

FIG. 8 illustrates an example set of defaulter value models produced at one of the steps in FIG. 3.

FIG. 9 is a high level flow diagram used to describe certain embodiments for generating the various types of cohort-based ML models in one of the steps in FIG. 3.

### DETAILED DESCRIPTION

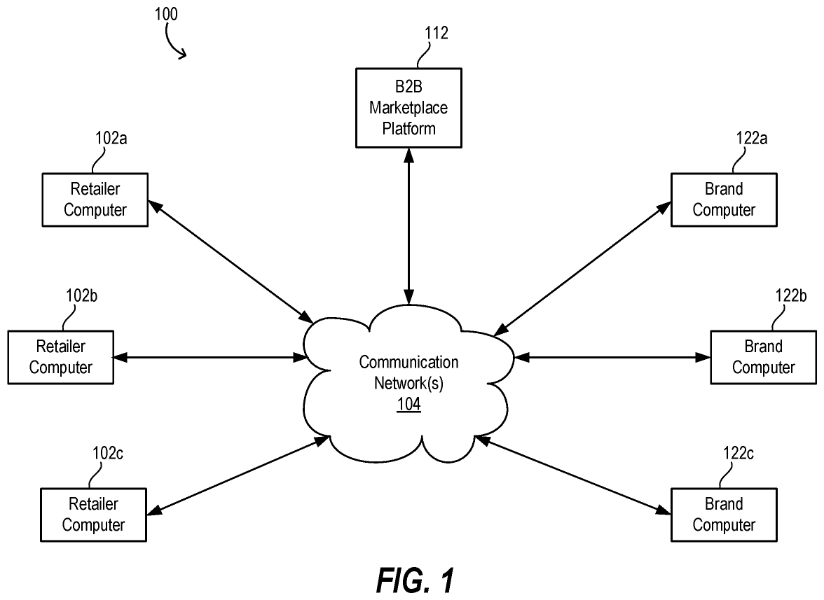

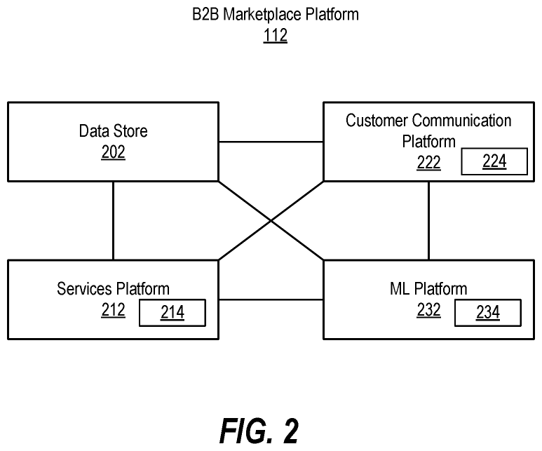

Certain embodiments of the present technology, as will be described below, relate to systems and methods for using machine learning to adjust (increase and/or decrease) credit limits that are provided to retailers that utilize a business-to-business (B2B) marketplace platform for purchasing products from brands (also referred to herein as wholesalers). More specifically, certain embodiments of the present technology utilize machine learning (ML) models to identify retailers whose credit limits should be adjusted. Additionally, certain embodiments of the present technology determine to what extent such identified retailers should have their credit limits adjusted. However, before providing additional details of such embodiments of the present technology, FIGS. 1 and 2 will initially be used to provide a description of an example environment in which embodiments of the present technology can be implemented.

Referring to FIG. 1, shown therein is an example computer implemented environment 100 including a plurality of retail computers 102a, 102b, 102c and a plurality of brand computers 122a, 122b, 122c that are able to interface with a B2B marketplace platform 112 via one or more communication network(s) 104. The communications network(s) 104 may include any suitable one or more communication networks, such as, the Internet, a wide area network (WAN), a metropolitan area network (MAN), a wireless local area network (WLAN), a personal area network (PAN) such as Bluetooth®, a radio access network (RAN) such as a Fifth Generation (5G) New Radio (NR) system, a wired network, a cable network, a satellite network, or combinations thereof, but are not limited thereto. The retail computers 102a, 102b, 102c, which can be referred to collectively as retail computers 102, or individually as a retail computer 102, are computers of retailers that sell products (aka goods) to consumers (aka customers) via online-stores and/or a brick and mortar (BM) stores. The brand computers 122a, 122b, 122c, which can be referred to collectively as brand computers 122, or individually as a brand computer 122, are computers of brands (aka wholesalers) that sell products (e.g., apparel, kitchenware, beauty and wellness supplies, home décor, jewelry) to the retailers. Each of the retail computers 102 and brand computers 122 can include, e.g., one or more processors, memory, a display, and a communication interface that enable the computers to access and thereby transmit and receive communication message via the communication network(s) 104. Example types of such computers 102 and 122 include personal computers (PCs), tablet computers, mobile phones, and/or the like.

The B2B marketplace platform 112 enables retailers to connect with brands (aka wholesalers), via the retailer computers 102, without needing to travel to multiple tradeshows, which travel can be expensive, time consuming, and can increase the carbon footprint of the retailers and the brands. For example, the B2B marketplace platform 112 offers retailers a toolkit of technology, data insights, financial terms, and logistics solutions to support the retailers using the retailer computers 102 to order products from the brands (aka wholesalers). Further, the B2B marketplace platform 112 enables brands (aka wholesalers) to connect with retailers, via the brand computers 122, without needing to navigate networks of independent sales representatives and travel to trade shows. For example, the B2B marketplace platform 112 offers brands a toolkit of technology, data insights, financial terms, and logistics solutions to support the brands using the brand computers 122 to sell their products to the retailers. In accordance with certain embodiments, software applications that are provided by the B2B marketplace platform 112 are software as a serve (SAAS) type software applications that retailers and brands can access via web-browsers on the retail computers 102 and the brand computer 122. Alternatively, the B2B marketplace platform 112 can provide downloadable type software applications that can be downloaded locally to the retail computers 102 and the brand computer 122.

FIG. 2 will now be used to provide example details of the B2B marketplace platform 112, introduced in FIG. 1. Referring to FIG. 2, the B2B marketplace platform 112 is shown as including data store 202, services platform 212, costumer communication platform 222, and machine learning (ML) platform 232. The data store 202 can, e.g., include one or more databases that store data about brands (aka brand data), data about products sold by brands (aka product data), data about retailers (aka retailer data), and/or the like. The data store 202 can, e.g., include a data lake that stores raw unstructured data and a data warehouse that stores structured and filtered data that has already been processed for one or more purposes. The data store 202 can be implemented using cloud and/or non-cloud based storage. As will be appreciated from the discussion below, certain types of retailer data for a retailer, that can be stored in the data store 202, are features and feature values for that retailer that are determined by ML models implemented within the ML platform 232.

The services platform 212 can include service applications implemented by one or more processors 214 to perform services that are offered by the B2B marketplace platform 112. Examples of such services include website support services, brand sales services for use by brands, brand purchasing services for use by retailers, data insight services, financial services, logistic (e.g., shipping) services, and/or the like.

For an individual retailer, the financial services provided by the service platform 212 can for example, keep track of the value(s) of one or more purchase orders made by the retailer, determine and keep track of a line of credit provided to the retailer, determine and keep track of whether or not the retailer has (or has not) defaulted on any payments that were due, and/or the like. A retailer may be considered to have defaulted on a payment for an order of products (aka a product order, or a brand order) from one or more brands if the payment has not been received by the date the payment was due (i.e., by the payment due date), or alternatively within a specific payment grace period (e.g., one week, or two weeks) following when the payment was due, depending upon the financial conditions to which the retailer and the B2B marketplace platform agreed (e.g., via an online contract). The payment may be considered due within a specified amount of payment time following when an order for products was made, or when (or within a specified amount of payment time following) the ordered products being shipped, depending upon the financial conditions to which the retailer and the B2B marketplace platform agreed (e.g., via an online contract). For example, a retailer, when placing an order for products, may have agreed that a payment for the ordered products is due within a specified payment time (e.g., one month, or two months) following when the retailer placed the order for the products. That retailer will be considered to have defaulted on their payment if the complete payment for the ordered product was not received by the due date, or alternatively within the specified payment grace period (e.g., one week, or two weeks) following when the payment for the products was due (e.g., the payment may have been due one month, or two months, following when the order was made). If the retailer makes only a partial payment by the due date, or within the payment grace period following the due date, then the retailer may be considered to have partially defaulted on their payment.

As will be appreciated from the discussion below, in accordance with certain embodiments of the present technology, the services platform 212 may utilize the ML platform 232 to autonomously identify a retailer whose credit limit should be adjusted (increased or decreased), and may utilize the ML platform 232 to determine the extent to which the retailer's credit limit should be adjusted. Additionally, in accordance with certain embodiments, the services platform 212 may autonomously adjust a retailer's credit limit based on predictions and/or other data produced by the ML platform 232.

Still referring to FIG. 2, the customer communication platform 222 can include communication applications implemented by one or more processors 224 to provide communications between various different types of customers of the B2B marketplace platform 112, which customers include the retailers and the brands, as well as to support communications between the B2B marketplace platform 112 and its customers (aka consumers). For example, the customer communication platform 222 can provide reminders to retailers of when a payment for an order is coming due and/or is past due. For another example, the customer communication platform 222 can also be used to inform a retailer that their credit limit has been adjusted, so that the retailer is made aware of the credit limit adjustment.

Still referring to FIG. 2, the ML platform 232 can include machine learning applications implemented by one or more processors 234 that implement ML models. In accordance with certain embodiments, such ML models are used to both identify low risk retailers and determine how much to increase a credit limit of such low risk retailers. In accordance with other embodiments, the ML models are used to both identify high risk retailers and determine how much to decrease a credit limit of such high risk retailers. In order to identify low risk retailers (or high risk retailers), cohort-based ML models are developed and periodically used (e.g., daily, every other day, weekly, monthly, or the like) to generate various scores for each retailer of a plurality of retailers that utilize the B2B marketplace platform 112, which scores can be used to identify low risk retailers, high risk retailers, as well as for other purposes, as will be appreciated from the below discussion.

Different processors can be used to implement the services platform 212, the customer communication platform 222, and the ML platform 232. In other words, the processors 214, 224, and 234 can differ from one another. Alternatively the same processors, or at least some of the same processors, can be used to implement the services platform 212, the customer communication platform 222, and the ML platform 232. In other words, the processors 214, 224, and 234 can be the same processors, or at least some of the processors 214, 224, and 234 can be the same processors.

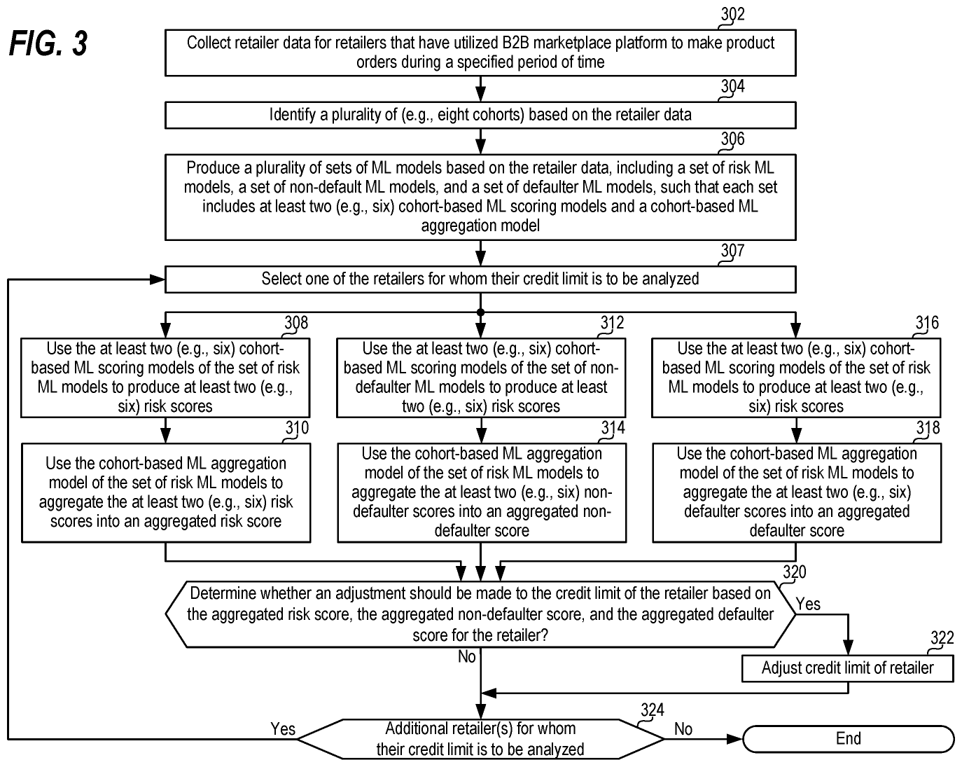

The high level flow diagram of FIG. 3 will now be used to summarize methods according to certain embodiments of the present technology that use machine learning to adjust a respective credit limit of one or more retailers that use a B2B marketplace platform (e.g., 212) to make product orders (aka brand orders). Certain embodiments discussed below describe how ML models can be used to both identify low risk retailers and determine how much to increase a credit limit of such low risk retailers, and/or both identify high risk retailers and determine how much to decrease a credit limit of such high risk retailers, in accordance with certain embodiments of the present technology. After the high level flow diagram of FIG. 3 is initially described below, additional details certain steps introduced with reference to FIG. 3 are provided.

Referring to FIG. 3, step 302 involves collecting retailer data for retailers that have utilized the B2B marketplace platform to make product orders (aka brand orders) during a specified period of time (e.g., during the past six months, or during the past year). This can include collecting backward looking features of retailers and collecting forward looking labels for retailers. Examples of backward looking features, which can also be referred to as retailer features, include, e.g., a number of payment attempts of the retailer that have failed, a type of payment instrument (e.g., credit card, debit card, checking account) used by the retailer, a number of social media followers, the retailer's annual average percentage use of their credit limit, whether the retailer is a brick & mortar retailer, whether the retailer is an online retailer, and/or the like. In accordance with certain embodiments, the retailer features that are collected at step 302 can include both offline features and online features, wherein the offline features are precalculated features generated periodically (e.g., each day), and online features are real time features generated when a brand order is made. For example, online features for a retailer can relate to a most recent brand order of the retailer prior to a certain cohort snapshot date (a specified calendar date).

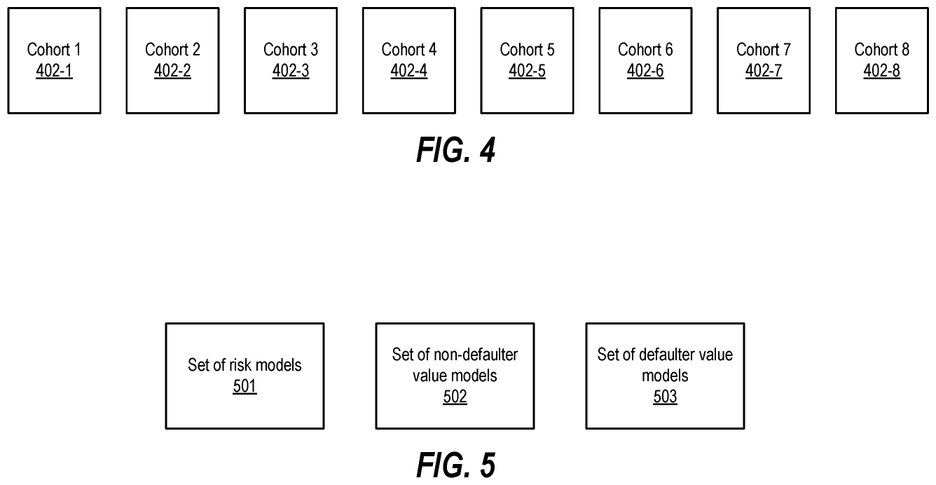

Step 304 involves identifying a plurality of cohorts (e.g., eight cohorts) based on the retailer data, wherein each cohort has a different respective cohort snapshot date within the specified period of time (e.g., within the past six months, or within the past year), and wherein each cohort includes a group of the retailers that made at least one of the product orders within a specified window of time (e.g., one month, or two months) that followed the cohort snapshot date. For example, the cohort snapshot dates associated with the plurality of cohorts (e.g., the eight cohorts) can be spaced apart from one another by one month or by two months, or by some other window of time. In other words, a cohort is defined as a group of retailers, who are registered with the B2B marketplace platform 112 on a certain cohort snapshot date (a specified calendar day), and made product orders within a specified window of time (e.g., one month, or two months) after the cohort snapshot date. The high level block diagram of FIG. 4, which is now referred to briefly, illustrates an example of the cohorts identified at step 304, assuming eight cohorts are identified at step 304, which cohorts are labeled 402-1, 402-2, 402-3, 402-4, 402-5, 402-6, 402-7, and 402-8 in FIG. 4. The example cohorts represented in FIG. 4 can be referred to collectively as the cohorts 402, or individually as a cohort 402. As will be described in additional detail below, a plurality of the cohorts 402 can be used to produce cohort-based ML scoring models and cohort-based ML aggregation models. For example, cohorts 402-1, 402-2, 402-3, 402-4, 402-5, and 402-6 can be used to produce cohort-based ML scoring models, and cohort 402-7 can be used to produce cohort-based ML aggregation models. Additionally, in certain embodiments, the retailer data of one of the cohorts 402 (e.g., the cohort 402-8) is used as a test cohort to test the cohort-based ML models producing using the other cohorts (e.g., 401-1 through 402-7). More specifically, each of the cohort-based ML models can be used to score each of the retailers in the cohort 402-8 (or more generally, the test cohort), and the model scores can be fed to the cohort-based ML aggregation models to generate a set of aggregated scores for each retailer for each of a plurality of sets of models, which set of aggregated scores includes an aggregated risk score, an aggregated non-defaulter value score, and an aggregated final defaulter value score for each retailer. Then, the aggregated scores can be compared with the actual retailer behaviors to determine the model performances.

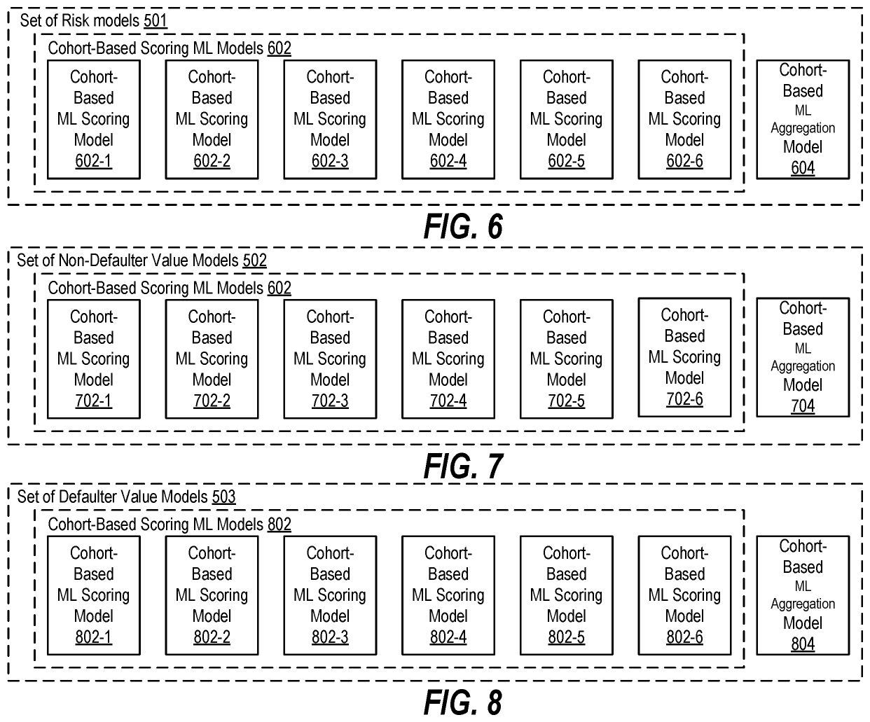

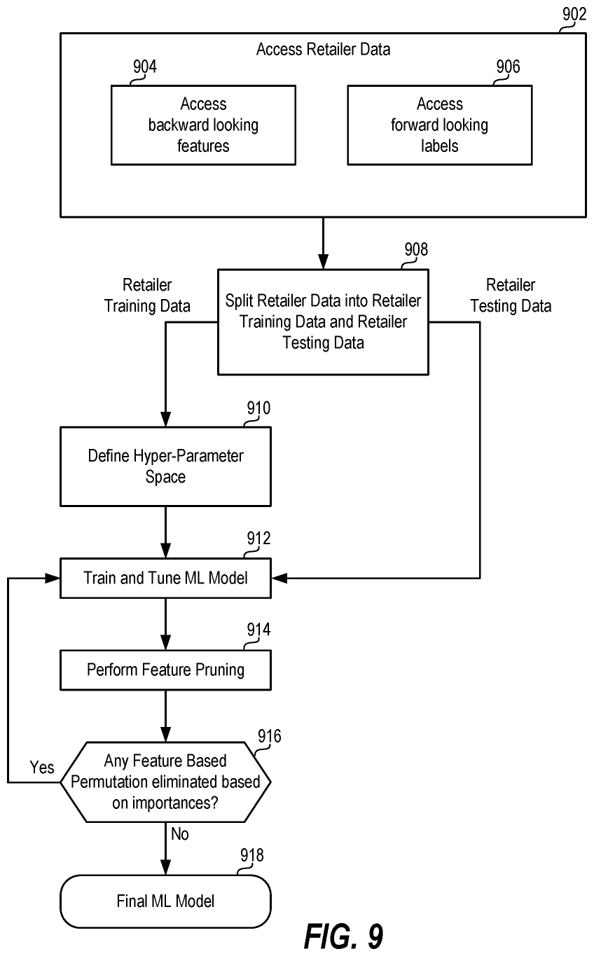

Referring again to FIG. 3, step 306 involves producing, based on the collected retailer data, a plurality of sets of ML models. The sets of models produced at step 306 are represented in the high level block diagram of FIG. 5, which shows a set of risk ML models 501, a set of non-defaulter value ML models 502, and a set of defaulter value ML models 503, which are all produced at step 306. In accordance with certain embodiments, the set of risk ML models 501 comprise classification models, and the set of non-defaulter value ML models 502 and the set of defaulter value ML models 503 comprise regression models, although other variations are also possible and within the scope of the embodiments described herein. In accordance with certain embodiments, each of the sets of the ML models 501, 502, and 503 includes a plurality of (e.g., seven) cohort-based ML models, which include at least two (e.g., six) cohort-based ML scoring models, and also include a cohort-based ML aggregation model. The high level block diagram of FIG. 6 illustrates an example set of risk models 501 produced at step 306, which include cohorts-based ML scoring models labeled 602-1, 602-2, 602-3, 602-4, 602-5, and 602-6, which can be referred to collectively as the cohorts-based ML scoring models 602, or individually as a cohort-based ML scoring model 602. FIG. 6 also illustrates the cohort-based ML aggregation model 604 of the set of risk models 501. The high level block diagram of FIG. 7 illustrates an example set of non-defaulter value models 502 produced at step 306, which include cohorts-based ML scoring models labeled 702-1, 702-2, 702-3, 702-4, 702-5, and 702-6, which can be referred to collectively as the cohorts-based ML scoring models 702, or individually as a cohort-based ML scoring model 702. FIG. 7 also illustrates the cohort-based ML aggregation model 704 of the set of non-defaulter value models 502. The high level block diagram of FIG. 8 illustrates an example set of defaulter value models 503 produced at step 306, which include cohorts-based ML scoring models labeled 802-1, 802-2, 802-3, 802-4, 802-5, and 802-6, which can be referred to collectively as the cohorts-based ML scoring models 802, or individually as a cohort-based ML scoring model 802. FIG. 8 also illustrates the cohort-based ML aggregation model 804 of the set of defaulter value models 503. Additional details of how the various ML models can be produced (aka generated) at step 306 are described further below with reference to FIG. 9.

Referring again to FIG. 3, step 307 involves selecting a retailer for whom their respective credit limit is to be analyzed, using ML models, for the purpose of determining whether their credit limit should be adjusted. For example, step 307 can involve selecting a retailer that has utilized the B2B marketplace platform (e.g., 212) to make product orders during the specified period of time (e.g., within the past six months, or within the past year).

Step 308 involves using the at least two (e.g., six) cohort-based ML scoring models 602 of the set of risk ML models 501 to produce at least two (e.g., six) risk scores. More specifically, at step 308, each of the cohort-based ML scoring models 602 of the set of risk ML models 501 produces a respective risk score indicative of a predictive risk that the retailer will default on at least one product order made within a further specified window of time (e.g., within the next month, or the next two months). Step 310 involves using the cohort-based ML aggregation model 604 of the set of risk ML models 501 to aggregate the at least two (e.g., six) risk scores, generated by the cohort-based ML scoring models 602, into an aggregated risk score indicative of a predictive risk that the retailer will default on at least one product order made within a further specified window of time (e.g., within the next month, or the next two months). Beneficially, on the test cohort, the aggregated risk score generated by the cohort-based ML aggregation model 604 has a lower cohort-specific bias and a better discriminative power than any individual one of the individual risk scores produced by the at least two (e.g., six) cohort-based ML scoring models 602 of the set of risk ML models 501.

Step 312 involves using the at least two (e.g., six) cohort-based ML scoring models 702 of the set of non-defaulter value ML models 502 to produce at least two non-defaulter value scores. More specifically, at step 312, each of the cohort-based ML scoring models 602 of the set of non-defaulter value ML models 502 produces a respective non-defaulter risk score indicative of a predicted value of one or more orders the retailer will make if the retailer does not default on any product orders within the further specified window of time. Step 314 involves using the cohort-based ML aggregation model 704 of the set of non-defaulter value ML models 502 to aggregate the at least two non-defaulter value scores into an aggregated non-defaulter value score indicative of a predicted value of one or more orders the retailer will make if the retailer does not default on any product orders within the further specified window of time. Beneficially, on the test cohort, the aggregated non-defaulter value score generated by the cohort-based ML aggregation model 704 has a lower cohort-specific bias and a higher coefficient of determination (R²) score than any individual one of the individual non-defaulter value scores produced by the at least two (e.g., six) cohort-based ML scoring models 702 of the set of non-defaulter value models 502.

Step 316 involves using the at least two (e.g., six) cohort-based ML scoring models 802 of the set of defaulter value ML models 503 to produce at least two defaulter value scores. More specifically, at step 316, each of the cohort-based ML scoring models 602 of the set of defaulter value ML models 503 produces a respective defaulter value score indicative of a predicted value of one or more orders the retailer will make if the retailer does default on at least one product order within the further specified window of time. Step 318 involves using the cohort-based ML aggregation model 804 of the set of defaulter value ML models 503 to aggregate the at least two defaulter value scores into an aggregated defaulter value score indicative of a predicted value of one or more orders the retailer will make if the retailer does default on at least one product order made within the further specified window of time. Beneficially, on the test cohort, the aggregated defaulter value score generated by the cohort-based ML aggregation model 804 has a lower cohort-specific bias and a higher coefficient of determination (R²) score than any individual one of the individual defaulter value scores produced by the at least two (e.g., six) cohort-based ML scoring models 802 of the set of defaulter value models 503.

Still referring to FIG. 3, step 320 involves determining whether to adjust the credit limit of the retailer based on the aggregated risk score, the aggregated non-defaulter value score, and the aggregated defaulter value score for the retailer, that were produced using the plurality of sets of ML models 501, 502, 503. For example, step 320 can involve determining an expected reward for the retailer based on the aggregated risk score, the aggregated non-defaulter value score, and the aggregated defaulter value score produced using the plurality of sets of ML models 501, 502, 503 for the retailer. More specifically, an equation that weights the aggregated risk score, the aggregated non-defaulter value score, and the aggregated defaulter value score, can be used to calculate an expected reward (e.g., a predicted profit or predicted loss) that the retailer is predicted to provide to the B2B marketplace platform. For example, the equation could be Expected reward=% commission*[Risk*defaulter+ (1−Risk)*non_defaulter]−Risk*defaulter, wherein % commission is a value between zero and one, Risk is the aggregated risk score indicative of a predictive risk that the retailer will default on at least one product order made within a further specified window of time (determined at step 310), non_defaulter is the aggregated non-defaulter value score indicative of a predicted value (e.g., a predicted gross merchandise value (GMV)) of one or more orders the retailer will make if the retailer does not default on any product orders within the further specified window of time (determined at step 314), and defaulter is the aggregated defaulter value score indicative of a predicted value (e.g., a predicted GMV) of one or more orders the retailer will make if the retailer does default on at least one product order made within the further specified window of time (determined at step 318). The use of alternative equations for calculating the expected reward is also possible and within the scope of the embodiments of the present technology described herein. Based on the expected reward and the aggregated risk score for the retailer, there can be a determination that the credit limit of the retailer should be increased if the expected reward for the retailer exceeds a corresponding reward threshold (e.g., is above zero, or is above some other specified reward threshold) and the aggregated risk score for the retailer is below a corresponding acceptable risk threshold. One or more other determinations may also be used when determining whether the credit limit of the retailer should be increased, as explained in further detail below. In other words, the credit limit of the retailer exceeding a corresponding reward threshold, and the aggregated risk score for the retailer being below a corresponding acceptable risk threshold, can be two of a plurality of various factors that are used when determining whether the credit limit of the retailer should be increased. Determining whether to adjust the credit limit of the retailer, at step 320, can additionally be based on one or more heuristics and/or criteria, such as, but not limited to, the retailer having a product return related below a specified threshold, at least a specified predetermined period of time has passed since the retailer's credit limit was last adjusted, and/or the like. Accordingly, it is noted that the phrase “based on” as used throughout this description means “based at least in part on”, meaning that a determination that is based on something may also be based on one or more additional factors, unless specifically specified otherwise.

In certain embodiments, determining whether to adjust the credit limit of the retailer at step 320 also includes determining whether the retailer is in need of an increased credit limit, such that the answer to the determination at step 320 will only be Yes if it is determined that the retailer is indeed in need of an increased credit limit. Another factor that can be used to determine whether the retailer is in need of an increased credit limit can be whether the aggregated non-defaulter value score for the retailer is higher than an unused portion of the current credit limit of the retailer, wherein the aggregated non-defaulter value score for the retailer being higher than the unused portion of the current credit limit of the retailer is considered indicative of the retailer being in need of an increased credit limit. Determining whether the retailer is in need of an increased credit limit can also be based on whether the retailer has made at least one product order with a specified window of time (e.g., 30 days, 60 days, or 90 days), whether at least a specified amount of time has passed since the retailer's credit limit was last increased, whether the retailer's unused credit limit balance is at least a specified amount more than their projected GMV, and/or the like.

If the answer to the determination at step 320 is Yes, then flow goes to step 322, and the credit limit of the retailer is adjusted. In certain embodiments, a further equation is used at step 322 to determine an increased credit limit of the retailer, or alternatively an amount by which to increase the credit limit of the retailer. Such further equation can, e.g., use the aggregated non-defaulter value score (determined at step 314) to determine the increased credit limit of the retailer, or the amount by which to increase the credit limit of the retailer, wherein as noted above the aggregated non-defaulter value score is indicative of a predicted value of one or more orders the retailer will make if the retailer does not default on any product orders within the further specified window of time. For example, a sum of a retailer's current balance plus their aggregated non-defaulter value score can be the retailer's new credit limit. It is also possible to use the mathematical ceiling function to determine the retailer's new credit limit such that credit limits are always increased in certain specified increments, e.g., of $500, or some other monetary incremental value. Credit decreases can be, for example, based on an aggregated defaulter value score and/or the aggregated risk score for the retailer, and may similarly be provided in specified monetary decremental values.

Still referring to FIG. 3, at step 324 there is a determination of whether there is at least one additional retailer for which an analysis should be performed to determine whether the credit limit of the retailer should be adjusted. If the answer to the determination is Yes at step 314, then flow returns to step 307 and the above described steps 308 through 320 (and possibly also step 322) are repeated for another one of the retails for which retailer data was collected. It is also possible that steps 308 through 320 (and possibly also step 322) are performed in parallel for multiple retailers simultaneously. If the answer to the determination at step 324 is No, then the method is ended until the next time (e.g., the next day, or some other specified time) the methodology is to be repeated using updated retailer data. For example, in certain embodiments, the aggregated risk score, the aggregated non-defaulter value score, and the aggregated defaulter value score are updated daily (or more or less frequently, depending upon implementation) for each retailer of at least some of the retailers, as new retailer data is collected, thereby enabling the determining whether to adjust the credit limit of at least some of the retailers to be repeated daily (or more or less frequently, depending upon implementation).

The high level flow diagram of FIG. 9 will now be used to describe methods for producing (aka generating) the cohort-based ML models described above with reference to FIGS. 6-8. Referring to FIG. 9, step 902 involves accessing retailer data (e.g., stored in the data store 202) for the cohort that is to be modeled using a ML model, wherein such retailer data was collected at step 302 described above with reference to FIG. 3. Step 902 can include accessing backward looking features for each retailer of a cohort at sub-step 904, and accessing forward looking labels for each retailer of the cohort at sub-step 906. In other words, for each cohort, the features that are accessed for a retailer are backward looking features. In addition to accessing backward looking features for retailers in each cohort, forward looking labels are also accessed. One type of forward looking label is whether a retailer has made at least one brand order within the specified window of time (e.g., one month, or two months) after the cohort snapshot date, and the retailer paid on time for the at least one brand order. Another type of forward looking label is the gross merchandise value (GMV) of all brand orders within the specified window of time (e.g., one month, or two months) after the cohort snapshot date.

Referring briefly back to FIGS. 2, 4 and 6-8, the retailer data associated with the cohort 402-1 can be accessed (e.g., from the data store 202) and used to produce the cohort-based ML scoring model 602-1 of the set of risk models 501, to produce the cohort-based ML scoring model 702-1 of the set of non-defaulter value models 502, and to produce the cohort-based ML scoring model 802-1 of the set of defaulter value models 503; the retailer data associated with the cohort 402-2 can be accessed and used to produce the cohort-based ML scoring model 602-2 of the set of risk models 501, to produce the cohort-based ML scoring model 702-2 of the set of non-defaulter value models 502, and to produce the cohort-based ML scoring model 802-1 of the set of defaulter value models 503; . . . and the retailer data associated with the cohort 402-6 can be accessed and used to produce the cohort-based ML scoring model 602-6 of the set of risk models 501, to produce the cohort-based ML scoring model 702-6 of the set of non-defaulter value models 502, and to produce the cohort-based ML scoring model 802-6 of the set of defaulter value models 503. Additionally, the retailer data associated with the cohort 402-7 can be used to produce the cohort-based ML aggregation model 604 of the set of risk models 501, to produce the cohort-based ML aggregation model 704 of the set of non-defaulter value models 502, and to produce the cohort-based ML aggregation model 804 of the set of defaulter value models 503.

Referring again to FIG. 9, step 908 involves splitting (aka separating) the retailer data for a cohort into a retailer training data set and a retailer testing data set using a random selection. For example, the splitting can be performed such that the training data set includes 80% of the retailer data for the cohort, and the retailer testing data set includes 20% of the retailer data for the cohort, but is not limited thereto. For another example, the splitting can be performed such that the training data set includes 67% of the retailer data, and the retailer testing data set includes 33% of the retailer data. Other variations are also possible and within the scope of the embodiments of the present technology described herein.

Step 910 involves defining a hyperparameter space that is to be searched against at a following step 912, wherein a hyperparameter is a parameter whose value is used to control the learning process in machine learning. By contrast, the values of other parameters, such as node weights of an ML model, are derived via training of the ML model. Examples of hyperparameters that may be defined include sampling weight of defaulters, number of boosting rounds, maximum tree depth, learning rate, subsample ratio of columns, subsample ratio of data points, just to name a few. However, it is noted that additional and/or alternative types of hyperparameters can be used while still being within the scope of the embodiments of the present technology described herein. In certain embodiments, hyperparameter space may be defined by default. Alternatively, the hyperparameter space may be optimized.

Step 912 involves training and tuning the ML model using the retailer training data set and the retailer testing data set. The specific type of training and tuning can depend on the size of the hyperparameter space defined at step 910. For example, where the hyperparameter space defined at step 910 is relatively small, then a grid search cross validation can be performed on the retailer training data set to perform model training and hyperparameter tuning simultaneously. For another example, where the hyperparameter space defined at step 910 is relatively large, a random search cross validation algorithm can be used to train and tune the ML model. Where numerous (e.g., thousands) of features are collected at step 902, and or more specially at sub-step 904, it may be beneficial to reduce the computation loads required to perform training step 912 and to reduce the likelihood of dropping pairs of useful features due to high correlation in feature pruning steps, data preprocessing can optionally be performed prior to step 912 (e.g., between steps 910 and 912) to remove certain features before running the training step 912.

Step 914 involves performing feature pruning based on permutation feature importances. More specifically, the permutation feature importance can be calculated for each feature in the ML model from step 912. The permutation feature importance is defined to be the decrease in a model score when a single feature value is randomly shuffled. For each feature, the ML model is run multiple times to thereby provide an empirical distribution of the permutation feature importance for each feature. If the mean value is not statistically significant, the feature is dropped (aka pruned). A feature may also be dropped if its permutation feature importance is too small compared to the most important feature, in order to prevent the ML model from overfitting the retailer data.

At step 916 there is a determination of whether any feature based permutation was eliminate based on importances during the most recent instance of step 914. If the answer to the determination at step 916 is Yes, the flow returns to step 912, and further training and tuning, and possibly pruning, of the ML model is performed. If the answer to the determination at step 916 is No, the flow goes to step 918 and the ML model for the cohort is finalized.

Referring back to FIGS. 6-8, the method described above with reference to FIG. 9 can be used to produce and train each of the cohort-based ML models, including those in the set of risk models 501, the set of non-defaulter value models 502, and the set of defaulter value models 503. More specifically, the method described above with reference to FIG. 9 can be used to produce and train each of the cohort-based ML scoring models 602-1 through 602-6, of the set of risk models 501. The method described above with reference to FIG. 9 can then be used to produce and train the cohort-based ML aggregation model 602-7, of the set of risk models 501, so that the cohort-based ML aggregation model 602-7 can produce an aggregated score for the set of risk models 501. The method described above with reference to FIG. 9 can also be used to produce and train each of the cohort-based ML scoring models 702-1 through 702-6, of the set of non-defaulter value models 502. The method described above with reference to FIG. 9 can then be used to produce and train the cohort-based ML aggregation model 702-7, of the set of non-defaulter value models 502. Additionally, the method described above with reference to FIG. 9 can be used to produce and train each of the cohort-based ML scoring models 802-1 through 802-6, of the set of defaulter value models 503. The method described above with reference to FIG. 9 can then be used to produce and train the cohort-based ML aggregation model 802-7, of the set of defaulter value models 503. The use of alternative methods to produce and train each of the cohort-based ML models are also within the scope of the embodiments of the present technology described herein.

A potential disadvantage of using cohort-based modeling to model the behaviors of retailers is that because different cohorts of retailers may behave inconsistently, cohort-based modeling may inadvertently introduce cohort-specific biases, which is undesirable. To reduce the probability of undesirable cohort-specific biases, while keeping the benefits of cohort-based modeling, within each of the sets of models 501, 502, and 503 multiple cohort based ML scoring models are defined (e.g., 602-1 through 602-6, 702-1 through 702-6, and 802-1 through 802-6) and a meta model is defined (i.e., the cohort-based ML aggregation models 604, 704, and 804), to generate periodic (e.g., daily) respective aggregated scores.

A benefit of using multiple cohort-based ML scoring models, within each of the sets of models 501, 502, and 503, is that even if one of the cohort-based ML scoring models is performing poorly, overall the models will perform well when their scores are aggregated. More specifically, each cohort-based ML aggregation model (604, 704, and 804) will have a better model performance than each of the individual cohort-based ML scoring models (e.g., 602-1 through 602-6, 702-1 through 702-6, and 802-1 through 802-6) of the set of models (e.g., 501, 502, or 503) that the cohort-based ML aggregation model is within. For example, the performance of certain types of ML models (e.g., classification models) can be measured as an Area Under the Curve (AUC), where the AUC equals 1 when the ML model performs perfectly, and the worst possible score is when the AUC equals 0. The performance of other types of ML models (e.g., regression models) can be measured as a coefficient of determination (R²), where the R² equals 1 when the ML model performs perfectly. Continuing with this example, the cohort-based ML aggregation model 604, of the set of risk models 501, will have a greater testing cohort AUC than any individual one of the cohort-based ML scoring models 602-1 through 602-6; the cohort-based ML aggregation model 704, of the set of non-defaulter value models 502, will have a greater testing cohort coefficient of determination (R²) score than any individual one of the cohort-based ML scoring models 702-1 through 702-6; and the cohort-based ML aggregation model 804, of the set of defaulter value models 503, will have a greater testing cohort coefficient of determination (R²) score than any individual one of the cohort-based ML scoring models 802-1 through 802-6.

In accordance with certain embodiments, when each of the cohort-based ML aggregation models 604, 704, and 804 is being trained, one or more cohort-based ML scoring models whose scores the aggregation model aggregates (e.g., one or more of the cohort-based ML scoring models 601-1 through 602-6, one or more of the cohort-based ML scoring models 701-1 through 702-6, and/or one or more of the cohort-based ML scoring models 801-1 through 802-6) may be dropped during a aggregation stage, if the cohort-based ML aggregation model doesn't benefit from those dropped models, so long as at least one cohort-based training ML models remains within each of the sets of models 501, 502, 503. In accordance with certain embodiments of the present technology, each of the ML models described herein are serialized objects stored in the cloud.

In accordance with certain embodiments, for each of the sets of models 501, 502, 503, periodically (e.g., once a month, or once every two months) an oldest one of the cohort-based ML scoring models and the cohort-based ML aggregation model produced for the set is retired, and a new cohort-based ML scoring model and a new cohort-based ML aggregation model is produced for each of sets of models. This can be achieved by periodically (e.g., once a month, or once every two months) identifying a new cohort based on retailer data collected since the cohorts were last identified at an instance of step 304 in FIG. 3. For example, referring back to FIG. 4, if the cohort snapshot dates associated with the cohorts 402-1 through 402-8 are spaced apart from one another by one month, then one month after the cohorts 402-1 through 402-8 were identified, a new cohort (e.g., 402-9, not shown) is identified. For another example, still referring back to FIG. 4, if the cohort snapshot dates associated with the cohorts 402-1 through 402-8 are spaced apart from one another by two months, then two months after the cohorts 402-1 through 402-8 were identified, a new cohort (e.g., 402-9, not shown), is identified. Once the new cohort is identified, the oldest cohort-based ML scoring model and the cohort-based ML aggregation model (within each of the sets of models 501, 502, 503) is retired. For example, referring back to FIGS. 6-8, once a new cohort (e.g., 402-9, not shown) is identified, the cohort-based ML scoring model 602-1 and the cohort-based ML aggregation model 604 within the set of risk models 501 is retired, the cohort-based ML scoring model 702-1 and the cohort-based ML aggregation model 704 within the set of non-defaulter value models 502 is retired, and the cohort-based ML scoring model 802-1 and the cohort-based ML aggregation model 804 within the set of defaulter value models 503 is retired. The cohort (e.g., 402-7) that had previously been used to produce the cohort-based ML aggregation model, within each of the sets of models 501, 502, 503, is used to produce a new cohort-based ML scoring model (e.g., 602-7, 702-7, 802-7, not specifically shown) for each of the sets of models, so that the number of cohort-based ML scoring model within each of the sets of models 501, 502, 503 remains the same (e.g., at six). The cohort (e.g., 402-8) that had been used for testing model performance is then used to produce a new cohort-based ML aggregation model for each of the sets of models 501, 502, 503. The new model (e.g., 402-9, not shown) that had been identified is used as a test cohort to test the cohort-based ML models.

Embodiments of the present technology described above utilize ML models to identify retailers whose credit limits should be adjusted, as well as to determine to what extent such identified retailers should have their credit limits adjusted, in a manner that both mitigates risks to the parties involved while also attempting to maximize the benefits to the parties involved. Such embodiments of the present technology provide significant improvements over past methodologies where credit limits were adjusted using human reviewers of the retailers' purchases, payment, and the like, as well as over past methodologies where credit limits were adjusted based on an output of a single ML model and one or more heuristics.

The subject matter described herein may be embodied in systems, apparatus, methods, and/or articles depending on the desired configuration. In particular, various implementations of the subject matter described herein may be realized in computer software, firmware or hardware and/or combinations thereof, as well as in digital electronic circuitry, integrated circuitry, and the like. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs), but not limited thereto) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, certain the subject matter described herein may be implemented on a computer having a display device (e.g., a touch-sensitive display, a non-touch sensitive display monitor, but not limited thereto) for displaying information to the user and a keyboard, touch screen and/or a pointing device (e.g., a mouse, touchpad or a trackball, but not limited thereto) by which the user may provide input to the computer. Other kinds of devices may be used to provide for interaction with a user, administrator and/or manager as well; for example, feedback provided to the user, administrator and/or manager may be any form of sensory feedback (e.g., visual feedback, auditory feedback, or tactile feedback); and input from the user may be received in any form, including acoustic, speech, or tactile input, depending upon implementation.

The subject matter described herein may be implemented in a computing system that includes a back-end component (e.g., as a data server), or that includes a middleware component (e.g., an application server), or that includes a front-end component (e.g., a client computer having a graphical user interface (GUI) or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include, but are not limited to, a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

While various embodiments of the present technology have been described above, it should be understood that they have been presented by way of example, and not limitation. It will be apparent to persons skilled in the relevant art that various changes in form and detail can be made therein without departing from the spirit and scope of the technology. For example, although a few variations have been described in detail above, other modifications or additions are possible. In particular, further features and/or variations may be provided in addition to those set forth herein. For example, the implementations described above may be directed to various combinations and sub-combinations of the disclosed features and/or combinations and sub-combinations of several further features disclosed above. In addition, the logic flow depicted in the accompanying figures and/or described herein do not require the particular order shown, or sequential order, to achieve desirable results. Other embodiments may be within the scope of the following claims.

Embodiments of the present technology have been described above with the aid of functional building blocks illustrating the performance of specified functions and relationships thereof. The boundaries of these functional building blocks have often been defined herein for the convenience of the description. Alternate boundaries can be defined so long as the specified functions and relationships thereof are appropriately performed. Any such alternate boundaries are thus within the scope and spirit of the claimed technology. One skilled in the art will recognize that these functional building blocks can be implemented by discrete components, application specific integrated circuits, processors executing appropriate software and the like or any combination thereof.

The breadth and scope of the present technology should not be limited by any of the above-described exemplary embodiments, but should be defined only in accordance with the following claims and their equivalents.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for using machine learning to adjust a respective credit limit of one or more retailers that utilize a business-to-business (B2B) marketplace platform to make product orders, the method comprising:
collecting retailer data for retailers that have utilized the B2B marketplace platform to make product orders during a specified period of time;
identifying a plurality of cohorts based on the retailer data;
producing, based on the retailer data, a plurality of sets of machine learning (ML) models that include a set of risk ML models, a set of non-defaulter value ML models, and a set of defaulter value ML models,
wherein each of the sets of the ML models includes a plurality of cohort-based ML models, and
wherein each of the plurality of cohort-based ML models, of each of the sets of the ML models, includes at least two cohort-based ML scoring models, and a cohort-based ML aggregation model;
for each retailer, of at least some of the retailers that have utilized the B2B marketplace platform to make product orders during the specified period of time,
using the at least two cohort-based ML scoring models of the set of risk ML models to produce at least two risk scores, and using the cohort-based ML aggregation model of the set of risk ML models to aggregate the at least two risk scores into an aggregated risk score;
using the at least two cohort-based ML scoring models of the set of non-defaulter value ML models to produce at least two non-defaulter value scores, and using the cohort-based ML aggregation model of the set of non-defaulter value ML models to aggregate the at least two non-defaulter value scores into an aggregated non-defaulter value score;
using the at least two cohort-based ML scoring models of the set of defaulter value ML models to produce at least two defaulter value scores, and using the cohort-based ML aggregation model of the set of defaulter value ML models to aggregate the at least two defaulter value scores into an aggregated defaulter value score; and
determining whether to adjust the credit limit of the retailer based on the aggregated risk score, the aggregated non-defaulter value score, and the aggregated defaulter value score for the retailer, that were produced using the plurality of sets of ML models.

2. The method of claim 1, wherein:
the aggregated risk score is indicative of a predictive risk that the retailer will default on at least one product order made within a further specified window of time;
the aggregated non-defaulter value score is indicative of a predicted value of one or more orders the retailer will make if the retailer does not default on any product orders within the further specified window of time; and
aggregated defaulter value score is indicative of a predicted value of one or more orders the retailer will make if the retailer does default on at least one product order made within the further specified window of time.

3. The method of claim 1, wherein:
the set of risk ML models comprise classification models; and
the set of non-defaulter value ML models and the set of defaulter value ML models comprise regression models.

4. The method of claim 1, wherein the producing, based on the retailer data, the plurality of sets of ML models that include the set of risk ML models, the set of non-defaulter value ML models, and the set of defaulter value ML models, includes for each cohort-based ML model included in the plurality of sets of ML models:
splitting the retailer data for one of the cohorts into retailer training data and retailer testing data;
training and tuning the ML cohort-based model using the retailer training data and the retailer testing data;
performing feature pruning on the ML model; and
finalizing the ML model after performing the feature pruning.

5. The method of claim 1, wherein the aggregated risk score, the aggregated non-defaulter value score, and the aggregated defaulter value score are updated daily for each retailer of at least some of the retailers, thereby enabling the determining whether to adjust the credit limit of at least some of the retailers to be repeated daily.

6. The method of claim 1, further comprising for each set of ML models, of the plurality of sets of the ML models that include the set of risk ML models, the set of non-defaulter value ML models, and the set of defaulter value ML models:
periodically retiring an oldest one of the at least two cohort-based ML scoring models and the cohort-based ML aggregation model produced for the set, and producing a new cohort-based ML scoring model and a new cohort-based ML aggregation model to be included in the plurality of cohort-based ML models.

7. The method of claim 1, wherein the determining whether to adjust the credit limit of the retailer includes:
determining an expected reward for the retailer based on the aggregated risk score, the aggregated non-defaulter value score, and the aggregated defaulter value score produced using the plurality of sets of ML models for the retailer; and
determining that the credit limit of the retailer should be increased responsive to the expected reward for the retailer exceeding a corresponding reward threshold and the aggregated risk score for the retailer being below a corresponding acceptable risk threshold.

8. The method of claim 7, further comprising, responsive to determining that the credit limit of the retailer should be increased, determining an increased credit limit of the retailer or an amount by which to increase the credit limit of the retailer.

9. The method of claim 8, wherein the determining the increased credit limit of the retailer or the amount by which to increase the credit limit of the retailer is performed based on the aggregated non-defaulter value score.

10. The method of claim 7, wherein:
the determining whether to adjust the credit limit of the retailer also includes determining whether the retailer is in need of an increased credit limit; and
the determining that the credit limit of the retailer should be increased is also responsive determining that the retailer is in need of the increased credit limit.

11. The method of claim 1, wherein the determining whether to adjust the credit limit of the retailer includes:
determining an expected reward for the retailer based on the aggregated risk score, the aggregated non-defaulter value score, and the aggregated defaulter value score produced using the plurality of sets of ML models for the retailer; and
determining that the credit limit of the retailer should be decreased responsive to the expected reward for the retailer falling below a corresponding reward threshold and the aggregated risk score for the retailer being indicative of the retailer having an unacceptable risk of defaulting.

12. The method of claim 11, further comprising, responsive to determining that the credit limit of the retailer should be decreased, determining a decreased credit limit of the retailer or an amount by which to decrease the credit limit of the retailer.

13. A system for using machine learning to adjust a respective credit limit of one or more retailers that utilize a business-to-business (B2B) marketplace platform to make product orders, the system comprising:
a data store that stores retailer data for retailers that have utilized the B2B marketplace platform to make product orders during a specified period of time;
one or more processors interfaced with the data store and configured to:
identify a plurality of cohorts based on the retailer data,
wherein each cohort, of the plurality of cohorts, has a different respective cohort snapshot date within the specified period of time, and
wherein each cohort, of the plurality of cohorts, includes a group of the retailers that made at least one of the product orders within a specified window of time following the cohort snapshot date;
produce, based on the retailer data, a plurality of sets of machine learning (ML) models that include a set of risk ML models, a set of non-defaulter value ML models, and a set of defaulter value ML models,
wherein each of the sets of the ML models includes a plurality of cohort-based ML models,
wherein each of the plurality of cohort-based ML models, of each of the sets of the ML models, includes at least two cohort-based ML scoring models, and a cohort-based ML aggregation model, and
wherein each of the plurality of cohort-based ML models, of each of the sets of the ML models, corresponds to a different cohort of the plurality of cohorts;
for each retailer, of at least some of the retailers that have utilized the B2B marketplace platform to make product orders during the specified period of time,
use the at least two cohort-based ML scoring models of the set of risk ML models to produce at least two risk scores, and using the cohort-based ML aggregation model of the set of risk ML models to aggregate the at least two risk scores into an aggregated risk score;
use the at least two cohort-based ML scoring models of the set of non-defaulter value ML models to produce at least two non-defaulter value scores, and using the cohort-based ML aggregation model of the set of non-defaulter value ML models to aggregate the at least two non-defaulter value scores into an aggregated non-defaulter value score;
use the at least two cohort-based ML scoring models of the set of defaulter value ML models to produce at least two defaulter value scores, and use the cohort-based ML aggregation model of the set of defaulter value ML models to aggregate the at least two defaulter value scores into an aggregated defaulter value score; and
determine whether to adjust the credit limit of the retailer based on the aggregated risk score, the aggregated non-defaulter value score, and the aggregated defaulter value score for the retailer, that were produced using the plurality of sets of ML models.

14. The system of claim 13, wherein:
the aggregated risk score is indicative of a predictive risk that the retailer will default on at least one product order made within a further specified window of time;
the aggregated defaulter value score is indicative of a predicted value of one or more orders the retailer will make if the retailer does default on at least one product order made within the further specified window of time; and
the aggregated non-defaulter value is score indicative of a predicted value of one or more orders the retailer will make if the retailer does not default on any product orders within the further specified window of time.

15. The system of claim 13, wherein:
the set of risk ML models comprise classification models; and
the set of non-defaulter value ML models and the set of defaulter value ML models comprise regression models.

16. The system of claim 13, wherein to produce, based on the retailer data, the plurality of sets of ML models that include the set of risk ML models, the set of non-defaulter value ML models, and the set of defaulter value ML models, includes for each cohort-based ML model included in the plurality of sets of ML models, the one or more processors are configured to:
split the retailer data for one of the cohorts into retailer training data and retailer testing data;
train and tune the ML cohort-based model using the retailer training data and the retailer testing data;
perform feature pruning on the ML model; and
finalize the ML model after the feature pruning is performed.

17. The system of claim 13, wherein the aggregated risk score, the aggregated non-defaulter value score, and the aggregated defaulter value score are updated daily by the system for each retailer of at least some of the retailers, thereby enabling the system determine daily whether to adjust the credit limit of at least some of the retailers.

18. The system of claim 13, for each set of ML models, of the plurality of sets of the ML models that include the set of risk ML models, the set of non-defaulter value ML models, and the set of defaulter value ML models, the one or more processors are further configured to:
periodically retire an oldest one of the at least two cohort-based ML scoring models and the cohort-based ML aggregation model produced for the set, and produce a new cohort-based ML scoring model and a new cohort-based ML aggregation model to be included in the plurality of cohort-based ML models.

19. The system of claim 13, wherein in order to determine whether to adjust the credit limit of the retailer, the one or more processors are configured to:
determine an expected reward for the retailer based on the aggregated risk score, the aggregated non-defaulter value score, and the aggregated defaulter value score produced using the plurality of sets of ML models for the retailer; and
determine that the credit limit of the retailer should be increased responsive to the expected reward for the retailer exceeding a corresponding reward threshold and the aggregated risk score for the retailer being below a corresponding acceptable risk threshold.

20. The system of claim 19, wherein responsive to a determination that the credit limit of the retailer should be increased, the one or more processors are configured to determine an increased credit limit of the retailer or an amount by which to increase the credit limit of the retailer.

21. The system of claim 20, wherein the one or more processors are configured to determine the increased credit limit of the retailer or the amount by which to increase the credit limit of the retailer based on the aggregated non-defaulter value score.

22. The system of claim 19, wherein the one or more processors:
in order to determine whether to adjust the credit limit of the retailer, are also configured to determine whether the retailer is in need of an increased credit limit and
determine that the credit limit of the retailer should be increased also responsive a determination that the retailer is in need of the increased credit limit.

23. The system of claim 13, wherein in order to determine whether to adjust the credit limit of the retailer, the one or more processors are configured to:
determine an expected reward for the retailer based on the aggregated risk score, the aggregated non-defaulter value score, and the aggregated defaulter value score produced using the plurality of sets of ML models for the retailer; and
determine that the credit limit of the retailer should be decreased responsive to the expected reward for the retailer falling below a corresponding reward threshold and the aggregated risk score for the retailer being indicative of the retailer having an unacceptable risk of defaulting.

24. The system of claim 23, wherein responsive to a determination that the credit limit of the retailer should be decreased, the one or more processors are configured to determine a decreased credit limit of the retailer or an amount by which to decrease the credit limit of the retailer.
